(19) United States
(12) Patent Application Publication
(10) Pub. No.: US 2012/0038306 A1
(43) Pub. Date: Feb. 16, 2012

(54) MEDIA DRIVE DEVICE

(75) Inventor: Takeshi HIGUCHI, Osaka (JP)

(73) Assignee: FUNAI ELECTRIC CO., LTD., Osaka (JP)

(21) Appl. No.: 13/191,426

(22) Filed: Jul. 26, 2011

(30) Foreign Application Priority Data
Aug. 16, 2010 (JP) 2010-181774

(51) Int. Cl. H02P 7/29

(52) U.S. Cl. 318/503

(57) ABSTRACT

The present invention discloses media drive device that turns a media by a motor, read data from the media and/or write data on to the media, that is comprised of a speed control unit that outputs a control pulse signal to control rotational speed of the motor and set adjusting quantity of the rotational speed by changing duty ratio of the control pulse, and a voltage up circuit that voltage up and generates driving voltage for driving the motor by switching operation that is based on the duty ratio of the control pulse.

### CROSS-REFERENCES TO RELATED APPLICATIONS

The entire disclosure of Japan Patent Application No. 2010-181774, filed Aug. 16, 2010, is expressly incorporated by reference herein.

### BACKGROUND OF THE INVENTION

1. Field of the Invention

This invention relates to a media drive device that is able to reduce electricity consumption.

2. Description of the Related Art

A media drive device such as a recorder or a HDD (hard disk drive) that reads recorded data from a media or writes data onto the media by a pick-up while turning the media in certain direction is well known in prior art. For example, in the recorders, while turning DVD disks or Blue-ray disks by a spindle motor, data on the disks are read from reflection light of laser beam irradiated onto the turning media surface.

In addition, it is necessary to generate power in order to drive the spindle motor to turn. Technologies to generate the power to drive the motor by increasing or decreasing certain input voltage power supplied from external sources are disclosed in Japanese Patent Laid-Open gazette H11-341,323 (Japanese Patent No. 4,048,599), Japanese Patent Laid-Open 2004-064971, Japanese Patent Laid-Open 2000-149,394 or Japanese Patent Laid-Open 2009-159,810.

A variety of power-saving technology for products is proposed these days in order to efficiently use limited energy. Therefore it is also desirable to reduce electricity consumption of the media drive device.

### BRIEF SUMMARY OF THE INVENTION

This invention relates to a media drive device which can reduce power consumption.

An embodiment of my invention is a media drive device that turns a media by a motor, read data from the media and/or write data on to the media, that is comprised of a speed control unit that outputs a control pulse signal to control rotational speed of the motor and set adjusting quantity of the rotational speed by changing duty ratio of the control pulse, and a voltage up circuit that voltage up and generates driving voltage for driving the motor by switching operation that is based on the duty ratio of the control pulse.

In the above structured embodiment, the speed control unit controls rotational speed of the motor by changing the duty ratio of the control pulse signal. In addition, the voltage up circuit generates and outputs the driving voltage to drive the motor. And the voltage up circuit increases the supplied voltage and generates the driving voltage by switching operation that is based on the duty ratio of the control pulse. Therefore the voltage up circuit generates the driving voltage that is set to a certain amount depending on the rotational speed of the motor based on the duty ratio of the control pulse signal. Thus it is only required to generates voltage value necessary to drive the motor, and reduces useless electricity and total electricity consumption.

### BRIEF DESCRIPTION OF THE DRAWINGS

FIG. 1 is a block diagram explaining main structure of a recorder 10.

FIG. 2 is a graph explaining speed change of a spindle motor 22b.

FIG. 3 is a figure showing relationship between duty ratio of control pulse signal and voltage value of second driving voltage V2.

FIG. 4 is a block diagram explaining structure of the recorder 10 in the second embodiment.

### DETAILED DESCRIPTION OF THE INVENTION

One of embodiments of the media drive device may be further comprised of a constant voltage circuit that supplies a driving voltage the amount of that is higher than the driving voltage provided by the voltage up circuit, and a switching unit that makes the constant voltage circuit supply driving power to the motor when the load of the motor is high, and makes the voltage up circuit supply driving power to the motor when the motor is driven at constant rotational speed.

According to the present embodiment, since power supply courses can be selected depending on high load or low load of the motor, the required voltage of the motor can be properly supplied.

In addition, in one of the other embodiments of the invention, the voltage up circuit generates the driving voltage based on a duty ratio of the control pulse signal that it is output from the speed control unit.

According to the present embodiment, during the load of the motor is low while the motor rotates at constant rotational speed, if the present invention is applied, the total capacity of the voltage up circuit can be less capacity.

In addition, in one of the other embodiments of this invention, the speed control unit sets the duty ratio of the control pulse signal depending on the rotational speed of the motor.

Further, in one of more concrete embodiments, the media drive device can be further comprised of a constant voltage circuit that supplies the driving voltage that is higher than the driving voltage that the voltage up circuit supplies, and a switching unit that makes the constant voltage circuit supply driving power to the motor when the load of the motor is high, and makes the voltage up circuit supply driving power to the motor when the motor is driven at constant rotational speed; wherein the voltage up circuit generates the driving voltage based on a duty ratio of the control pulse signal that it is output from the speed control unit, and the speed control unit sets the duty ratio of the control pulse signal depending on the rotational speed of the motor.

Embodiments of the present invention will be explained in detail according to the following order.

1. The first embodiment:
1.1. The structure of media drive devices:
1.2. The change of power supply while playing medias:

2. The second embodiment:

3. Other embodiments:

### 1. The First Embodiment

1.1. The Structure of Media Drive Devices:

Hereinafter, the first embodiment of the media drive device will be explained in detail by referring figures. In this embodiment, as an example of the media drive device, an explanation will be given based on a recorder 10.

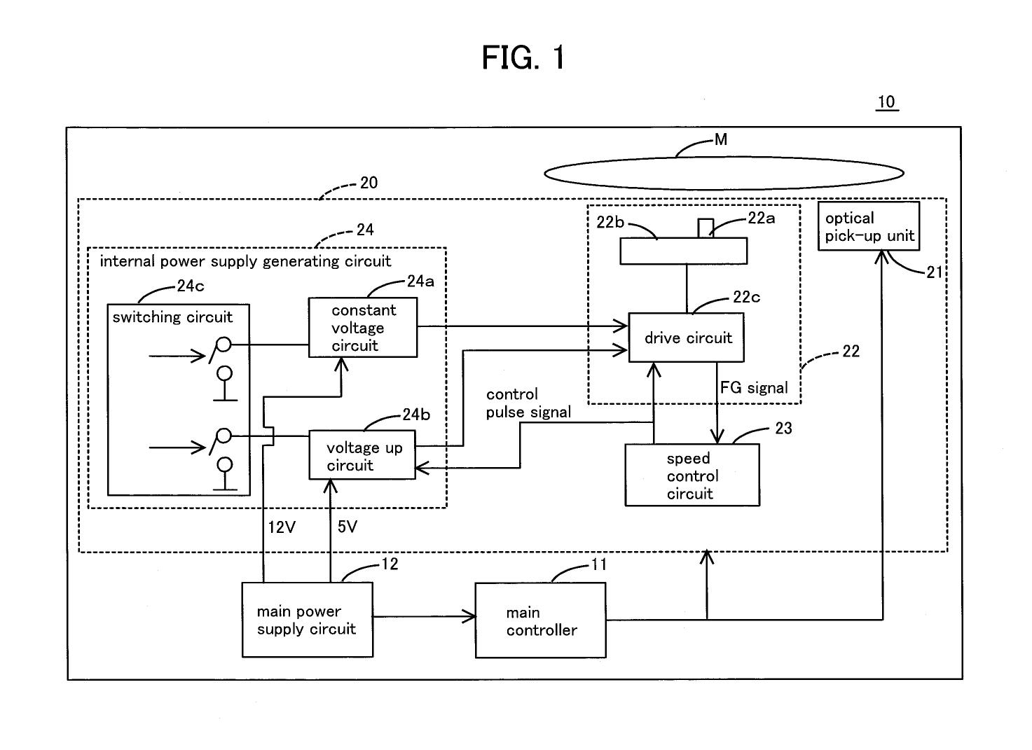

FIG. 1 is block diagram of the recorder 10. The recorder 10 reads data recorded on a media M or write the data on the media M. The Media M is one of DVD disks, Blue-ray Disks (a registered trademark) or etc. The recorder 10 comprises a drive unit 20, a main controller 11 and main power supply circuit 12 as shown in FIG. 1. The drive unit 20 performs reading data from or recording data to the media M. The main controller 11 totally performs driving control of the recorder 10. The main power supply circuit 12 supplies drive power to the recorder 10.

The main power supply circuit 12 comprises a rectifying circuit, a smoothing circuit and a depression circuit. The main power supply circuit 12 generates stabilized power based on supplied power from outside power supplies such as commercial power supplies. In this embodiment, the main power supply circuit 12 generates ‘12V’ general power supply and 5V general power supply for the drive unit 20. The main power supply circuit 12 also generates 3.3V general power supply and 5V general power supply for the main controller 11.

The main controller 11 comprises a CPU (Central processing unit), a ROM (read only memory), and a RAM (random access memory). The ROM stores programs that the CPU runs. The RAM is used as working area by the CPU.

The drive unit 20 is a unit that performs reading data from or recording data to the media M. The drive unit 20 comprises an optical pick-up unit 21, a spindle unit 22, a speed control circuit (a speed control unit) 23 and an internal power supply generating circuit 24.

The optical pick-up unit 21 comprises a semiconductor laser, a light detector, and an object lens. The optical pick-up unit 21 condenses laser beam emit from the semiconductor laser by the object lens, and irradiates the laser beam on to a data recording surface of the media M. Thus the optical pick-up unit 21 performs the recording or reading data.

The spindle unit 22 comprises a spindle part 22a, a spindle motor 22b, and a drive circuit 22c. The spindle part 22a fixes media M with its center axis. The spindle motor 22b turns the spindle part 22a. The drive circuit 22c drives the spindle motor 22b. In this embodiment, the spindle motor 22b comprises a brush-less motor. The brush-less motor turns based on the detection result of a hall element. The hall element is supplied electric current from the drive circuit 22c. The drive circuit 22c changes the amount of electric current that is supplied to the spindle motor 22b depending on a control pulse signal output from the speed control circuit 23 (as described later), and coordinates rotational speed of the spindle motor 22b.

The speed control circuit 23 outputs control pulse signal based on the rotational speed of spindle motor 22b. The control pulse signal is a signal to control the rotational speed of the spindle motor 22b. In this embodiment, the speed control circuit 23 convert rotary signal to variation of the pulses. The rotary signal corresponds to a turning of the spindle motor 22b. The speed control circuit 23 converts the rotary signal by F (frequency)/V (the voltage) conversion. The speed control circuit 23 performs voltage comparison, and outputs control pulse signal generated depending on the comparison result to the drive circuit 22c of the spindle unit 22. Such control is so-called the FG control. In this embodiment, FG signal output from the spindle unit 22 is used as the rotary signal. The FG signal is well-known signal output depending on a number of rotation of the spindle motor 22b. Of course, as well as the FG signal, another rotary signal such as a signal that is output when the rotation of the spindle motor 22b is directly detected.

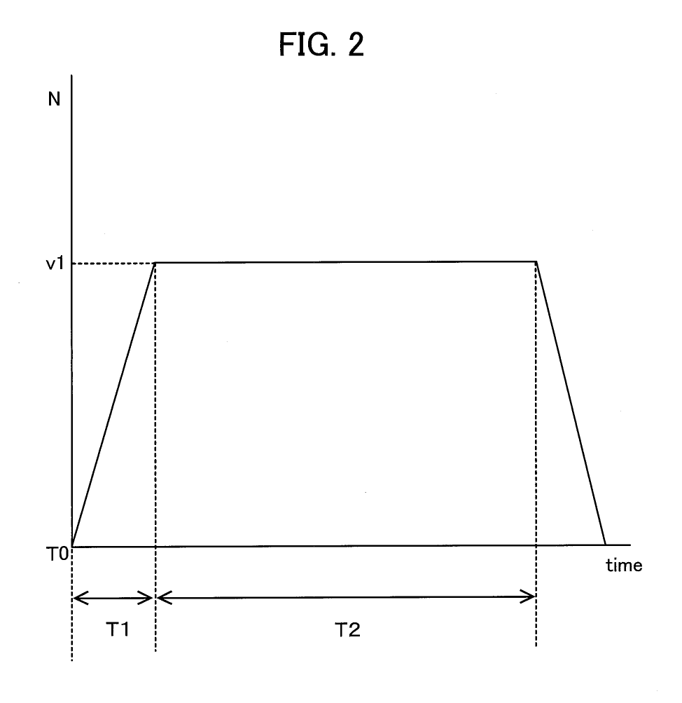

FIG. 2 is a graph to explain speed change of the spindle motor 22b. In the figure, the horizontal axis shows time, and the vertical axis shows rotational speed N (rpm). As for the control pulse signal output from the speed control circuit 23, the duty ratio is set depending on the quantity of speed adjustment for the spindle motor 22b. In this embodiment, the duty ratio of the control pulse signal is set more than 50% when the spindle motor 22b begins to be driven (T0) and during the accelerating period (T1). On the other hand, the duty ratio of the control pulse signal is set to 50% while spindle motor 22b is driven in constant speed driving period (T2). In other words, since there is no change of the rotational speed while the spindle motor 22b is driven in constant speed driving period (T2), the duty ratio of the control pulse signal is maintained to be 50%.

The internal power supply generating circuit 24 generates driving voltage that will be supplied to the spindle unit 22. The internal power supply generating circuit 24 comprises a constant voltage circuit 24a, a voltage up circuit 24b, and a switching circuit (a switching unit) 24c. The constant voltage circuit 24a generates the first driving voltage V1 of ‘12V’ from 12V general power supply supplied by the main power supply circuit 12. The voltage up circuit 24b generates the second driving voltage V2 of ‘7.5V’ from 5V general power supply supplied by the main power supply circuit 12. The switching circuit 24c switches the voltage to be supplied to the spindle unit 22 between the first driving voltage V1 and the second driving voltage V2.

For example, the switching circuit 24c is equipped with operation parts such as CPU's. The switching circuit 24c changes the driving voltage that is supplied to the spindle unit 22 depending on the load of the spindle motor 22b. When the spindle motor 22b starts to be driven (T0) and during the spindle motor 22b is accelerating period (T1), since the switching circuit 24c performs above mentioned control, the constant voltage circuit 24a supplies the first driving voltage V1 of ‘12V’ to the spindle unit 22. When the spindle motor 22b starts to be driven (T0) and during the spindle motor 22b is accelerated (accelerating period T1), the load of the spindle motor 22b is high. Since the load is high, it requires much power to be supplied. On the other hand, while the spindle motor 22b is driven in constant speed driving period (T2), since the switching circuit 24c performs the switching operation mentioned above, the second driving voltage V2 of ‘7.5V’ is supplied from the voltage up circuit 24b to the spindle unit 22. During the spindle motor is driven in constant speed, that is constant speed driving period (T2), the load of the spindle motor 22b is low, and it does not require much power to be supplied. The switching control of the driving voltages by the switching circuit 24c is set beforehand based on a speed table of the spindle motor 22b.

The voltage up circuit 24b comprises a separately excited oscillation circuit that generates the second driving voltage V2 of ‘7.5V’ from the 5V general power supply supplied by the main power supply circuit 12. Therefore, an oscillation pulse from outside is supplied to the voltage up circuit 24b. For example, the voltage up circuit 24b comprises a switching IC (integrated circuit) and a transformer T. When the switching IC is supplied of the oscillation pulse, internal transistors performs switching operation. The transformer T supplies the voltage (the second driving voltage V2) to the spindle unit 22. The voltage (the second driving voltage V2) is generated by voltage up operation by the switching IC.

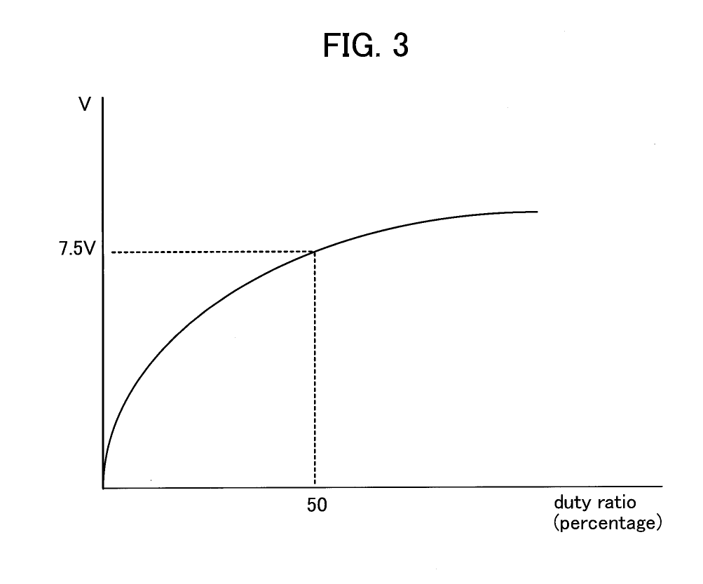

The voltage up circuit 24b performs switching operation based on the oscillation pulse. In this embodiment, the control pulse signal output from the speed control circuit 23 is used as the oscillation pulse by the voltage up circuit 24b. FIG. 3 shows the relationship between the duty ratio of the control pulse signal and the voltage value of the second driving voltage V2. In FIG. 3, the horizontal axis shows the duty ratio (a percentage) of the control pulse signal, and the vertical axis shows the voltage value (V) of the second driving voltage V2. Due to a plurality of parameters are set for the voltage up circuit 24b, the voltage up circuit 24b generates the second driving voltage V2 of ‘7.5V’ when the duty ratio of the control signal (the oscillation pulse) is 50%. As a result, during the spindle motor is driven in constant speed, that is constant speed driving period (T2), the internal power supply generating circuit 24 supplies the second driving voltage V2 of ‘7.5V’ to the spindle unit 22.
1.2. The Switching Operation of the Power Supply at the Time of Media Reproduction:

Hereinafter, the switching operation of the power supply performed by the recorder 10 when the recorder 10 replays data recorded on the Media as follows. In addition, the switching operations of the power supply that is performed by the reorder 10 when the recorder 10 plays the media or records data on the media M are same. Therefore, following explanation will be the one for the former operation, and the other one for the latter one will be omitted.

When the main controller 11 outputs a drive instruction, the spindle unit 22 drives the spindle motor 22b and the media M rotates. During the period (T0) in FIG. 2, the first driving voltage V1 of ‘12V’ is supplied to the drive circuit 22c from the constant voltage circuit 24a under the control of the switching circuit 24c. During the accelerating period (T1), the speed control circuit 23 outputs the control pulse signal that is set with the duty ratio depending on the number of rotations of the spindle motor 22b to the drive circuit 22c. The control pulse signal is set with the duty ratio depending on the number of rotations of the spindle motor 22b beforehand. Therefore the rotational speed of the spindle motor 22b changes from ‘0’ to ‘v1’ during the accelerating period (T1).

When the speed of the spindle motor 22b reaches ‘v1’, the speed control circuit 23 maintains the duty ratio of the control pulse signal to 50%. Therefore the drive circuit 22c starts a constant rotational speed driving of the spindle motor 22b (constant rotation speed driving period T2).

When the spindle motor 22b shifts to constant rotational speed driving, the switching circuit 24c performs switching so that the second driving voltage V2 of ‘7.5V’ will be supplied to the drive circuit 22c from the voltage up circuit 24b. Then the control pulse signal that means the duty ratio of 50% is supplied to the switching IC of the voltage up circuit 24b. The voltage up circuit 24b performs increasing the voltage by using the control pulse signal as the oscillation pulse. Thereafter the second driving voltage V2 of ‘7.5V’ is generated from the 5V general power supply supplied by the main power supply circuit 12, and the second driving voltage V2 is supplied to the spindle unit 22.

In the constant rotational speed driving period (T2), the spindle unit 22 will be driven by the second driving voltage V2 of ‘7.5V’ afterward. Therefore, in the constant rotational speed driving period (T2), the electricity consumption amount will be reduced than when it is driven by the first driving voltage V1. In addition, since the voltage up circuit 24b is required to generate the second driving voltage V2 of ‘7.5V’ at the maximum, the capacity of the circuit can be less.

### 2. The Second Embodiment

The internal power supply generating circuit 24 can be comprised of only the voltage up circuit 24b, and the voltage up circuit 24b may generate the driving voltage of ‘7.5V’ to ‘12V’ depending on the duty ratio of the control pulse signal output by the speed control circuit 23.

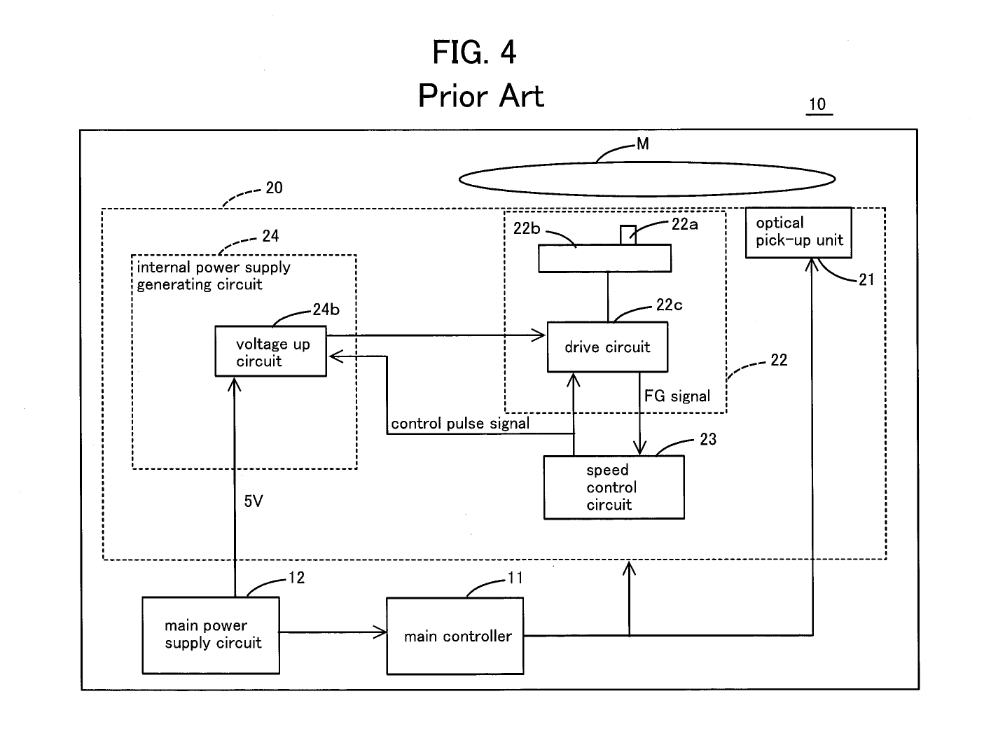

FIG. 4 is a block diagram explaining structure of the recorder 10 in the second embodiment. Since the spindle unit 22 needs driving voltage of ‘7.5V’ to ‘12V’ in the accelerating period T1 of the spindle motor 22b. Therefore the voltage up circuit 24b set the parameters of the switching IC so that the voltage up circuit 24b generates the driving voltage of ‘7.5V’ to ‘12V’ when it oscillates in accordance with the duty ratio (for example, duty ratio of 50% to 75%) of the control pulse signal. The internal power supply generation circuit 24 will be simplified much more because of the above-mentioned composition.

### 3. Other Embodiments

There are various embodiments in this invention. The recorder 10 is not limited to the above mentioned recorder, and the present invention may be a television set comprising the recorder mentioned above.

The above explained recorder 10 can reduce the consumption of useless electricity thus reduces consumption of total electricity. This is because the voltage up circuit 24b generates a certain amount of the driving voltage that is set depending on the rotational speed of the spindle motor 22b, thus it only generates only a necessary driving voltage in order to drive the spindle motor 22b.

While the invention has been particularly shown and described with respect to preferred embodiments thereof, it should be understood by those skilled in the art that the foregoing and other changes in form and detail may be made therein without departing from the spirit and scope of the invention as defined in the appended claims.

Although the invention has been described in considerable detail in language specific to structural features and or method acts, it is to be understood that the invention defined in the appended claims is not necessarily limited to the specific features or acts described. Rather, the specific features and acts are disclosed as preferred forms of implementing the claimed invention. Therefore, while exemplary illustrative embodiments of the invention have been described, numerous variations and alternative embodiments will occur to those skilled in the art.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, proximal, distal, etc. have been used for convenience purposes only and are not intended to imply any particular fixed direction or orientation. Instead, they are used to reflect relative locations and/or directions/orientations between various portions of an object.

In addition, reference to “first,” “second,” “third,” and etc. members throughout the disclosure (and in particular, claims) is not used to show a serial or numerical limitation but instead is used to distinguish or identify the various members of the group.

What is claimed is:

1. A media drive device that turns a media by a motor, read data from the media and/or write data on to the media, that is comprised of
a speed control unit that outputs a control pulse signal to control rotational speed of the motor and set adjusting quantity of the rotational speed by changing duty ratio of the control pulse signal, and
a voltage up circuit that voltage up and generates driving voltage for driving the motor by switching operation that is based on the duty ratio of the control pulse signal.

2. The media drive device of claim 1, that is further comprised of
a constant voltage circuit that supplies a driving voltage the amount of that is higher than the driving voltage provided by the voltage up circuit,
a switching unit that makes the constant voltage circuit supply driving power to the motor when the load of the motor is high, and makes the voltage up circuit supply driving power to the motor when the motor is driven at constant rotational speed.

3. The media drive device of claim 1, wherein the voltage up circuit generates the driving voltage based on a duty ratio of the control pulse signal that it is output from the speed control unit.

4. The media drive device of claim 1, wherein the speed control unit sets the duty ratio of the control pulse signal depending on the rotational speed of the motor.

5. The media drive device of claim 1, that is further comprised of
a constant voltage circuit that supplies the driving voltage that is higher than the driving voltage that the voltage up circuit supplies, and
a switching unit that makes the constant voltage circuit supply driving power to the motor when the load of the motor is high, and makes the voltage up circuit supply driving power to the motor when the motor is driven at constant rotational speed; wherein
the voltage up circuit generates the driving voltage based on a duty ratio of the control pulse signal that it is output from the speed control unit, and
the speed control unit sets the duty ratio of the control pulse signal depending on the rotational speed of the motor.
